(19) United States
(12) Patent Application Publication
(10) Pub. No.: US 2016/0077516 A1
(43) Pub. Date: Mar. 17, 2016

(54) DATA COMPENSATION DEVICE, DATA COMPENSATION METHOD, AND MACHINING APPARATUS

(71) Applicant: Kabushiki Kaisha Toshiba, Minato-ku (JP)

(72) Inventor: Akira KOJIMA, Kawasaki (JP)

(73) Assignee: Kabushiki Kaisha Toshiba, Minato-ku (JP)

(21) Appl. No.: 14/849,730

(22) Filed: Sep. 10, 2015

(30) Foreign Application Priority Data
Sep. 16, 2014 (JP) 2014-187247
Aug. 31, 2015 (JP) 2015-170730

(51) Int. Cl. G05B 19/404; G01K 15/00

(52) U.S. Cl. CPC G05B 19/404; G01K 15/00; G05B 2219/49217

(57) ABSTRACT

According to one embodiment, a data compensation device includes a temperature measuring unit, a position measuring unit and a calculating unit. The temperature measuring unit measures an environmental temperature in a vicinity of a machining apparatus. The position measuring unit measures a position of a component of the machining apparatus decided in advance. The calculating unit calculates a geometric error compensation value corresponding to each of a plurality of environmental temperatures on the basis of the environmental temperature measured by the temperature measuring unit, the position of the component measured by the position measuring unit, and the position of the component decided in advance.

### CROSS-REFERENCE TO RELATED APPLICATIONS

This application is based upon and claims the benefit of priorities from the prior Japanese Patent Application No. 2014-187247, filed on Sep. 16, 2014, and the prior Japanese Patent Application No. 2015-170730, filed on Aug. 31, 2015; the entire contents of which are incorporated herein by reference.

### FIELD

Embodiments described herein relate generally to a data compensation device, a data compensation method, and a machining apparatus.

### BACKGROUND

There is a machining apparatus that receives inputs of data of a machine, work, and the like and machines the work using a plurality of control axes. In the machining apparatus, the position of an actual machining point is sometimes different from the position of a machining point determined on the basis of the input data. A positioning error that occurs in each of the plurality of control axes is caused by the configuration of the machining apparatus, a force applied to the machining apparatus, an environment in which the machining apparatus is set, and the like.

In order to compensate such a positioning error, there has been proposed a technique for providing a measuring device that measures an actual position and calculating a compensation value from a difference between measurement data and input data. However, an environmental temperature changes as time elapses. The compensation value also changes because of thermal expansion and the like. Therefore, the measurement and the calculation of the compensation value are necessary every time machining is performed. Propriety of compensation is often unknown unless machining is actually performed using calculated compensation. Since the positioning error affects machining accuracy of the work, there is a demand for a machining apparatus that can perform machining with higher machining accuracy.

### BRIEF DESCRIPTION OF THE DRAWINGS

FIG. 1 is a schematic view showing a machining apparatus according to an embodiment;

FIG. 2A and FIG. 2B are schematic views showing the machining apparatus according to the embodiment;

FIG. 3 is a diagram for describing occurrence of a positioning error;

FIG. 4A to FIG. 4C are schematic views showing an example in which NC data is compensated by a part of the machining apparatus according to the embodiment; and

FIG. 5 is a flowchart for describing a data compensation method according to the embodiment.

### DETAILED DESCRIPTION

According to one embodiment, a data compensation device includes a temperature measuring unit, a position measuring unit and a calculating unit. The temperature measuring unit measures an environmental temperature in a vicinity of a machining apparatus. The position measuring unit measures a position of a component of the machining apparatus decided in advance. The calculating unit calculates a geometric error compensation value corresponding to each of a plurality of environmental temperatures on the basis of the environmental temperature measured by the temperature measuring unit, the position of the component measured by the position measuring unit, and the position of the component decided in advance.

Embodiments of the invention are described below with reference to the drawings.

Note that, the drawings are schematic or conceptual. Relations between thicknesses and widths of portions, ratios of sizes among the portions, and the like are not always the same as real ones. Even when the same portions are shown, the portions are sometimes shown in different dimensions and ratios depending on the drawings.

Note that in the specification and the drawings, components described with reference to the drawings already referred to are denoted by the same reference numerals and signs. Detailed description of the components is omitted as appropriate.

### EMBODIMENT

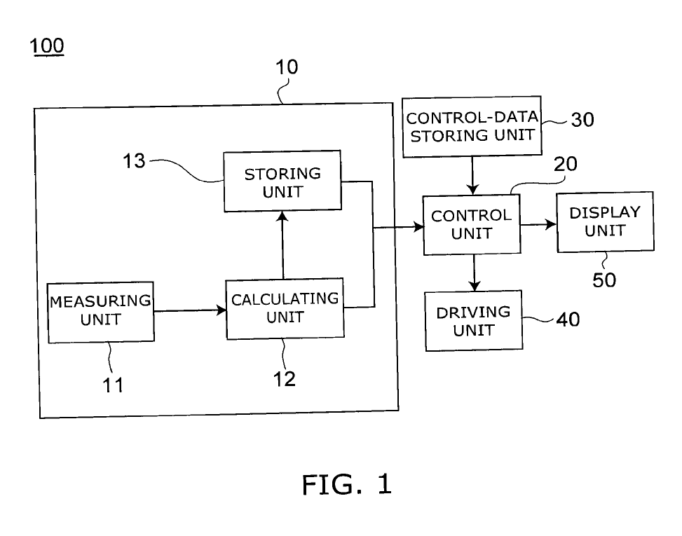

FIG. 1 is a schematic view showing a machining apparatus according to an embodiment.

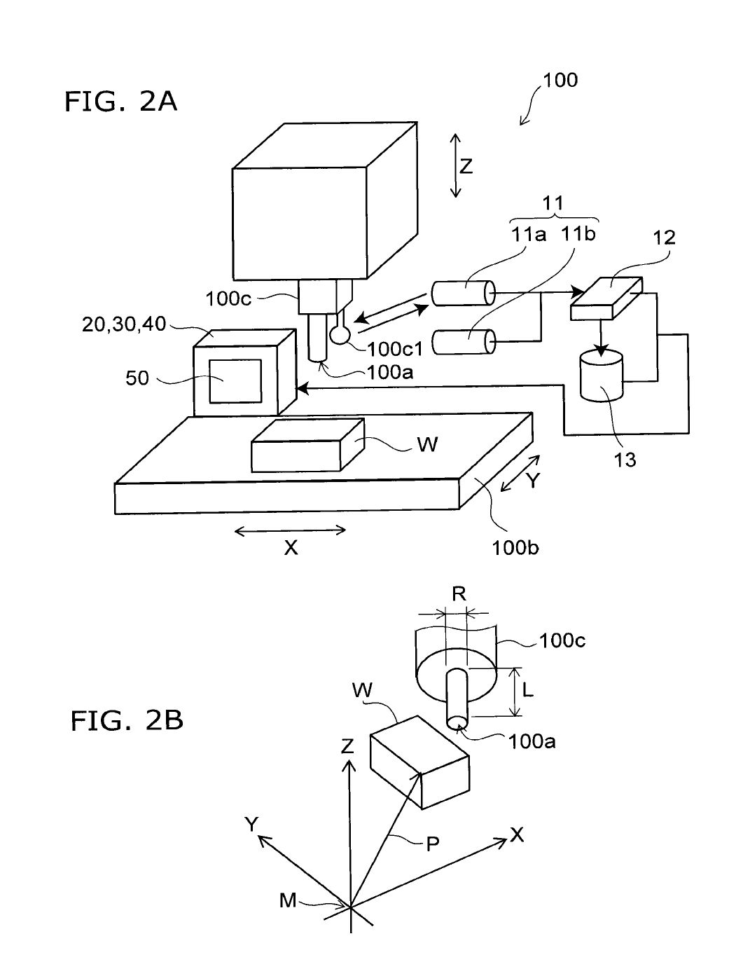

FIG. 2A and FIG. 2B are schematic views showing the machining apparatus according to the embodiment.

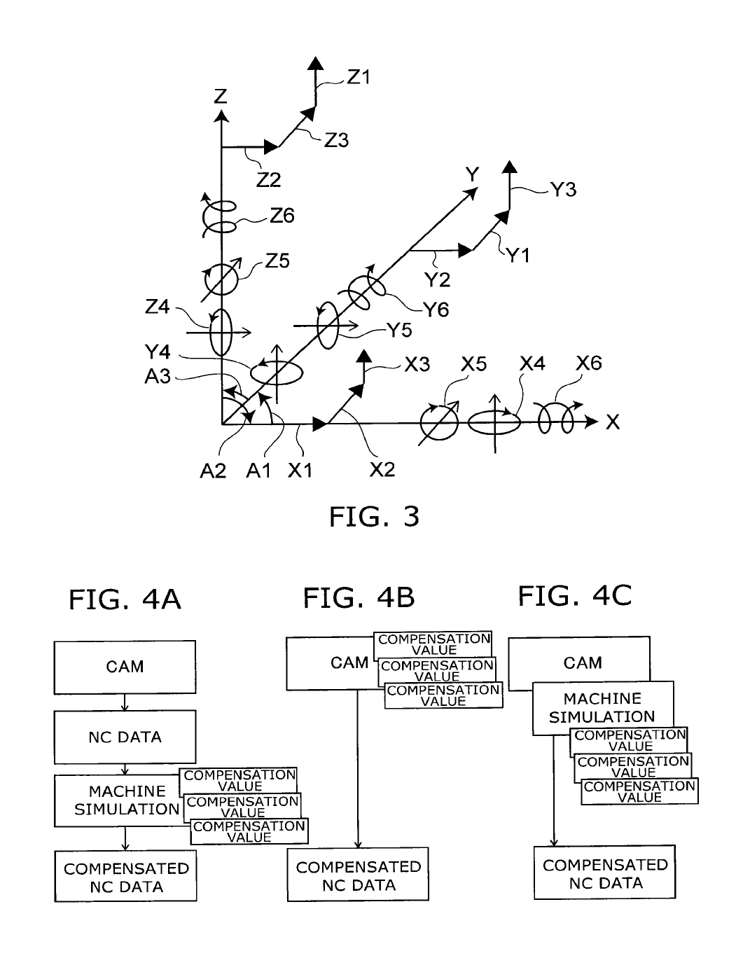

FIG. 3 is a diagram for describing occurrence of a positioning error.

FIG. 4A to FIG. 4C are schematic views showing an example in which NC data is compensated by a part of the machining apparatus according to the embodiment.

In FIG. 1, a block diagram of a machining apparatus 100 is shown. In FIG. 2A, an external view of the machining apparatus 100 is shown. In FIG. 2B, a positional relation between the machining apparatus 100 and work is shown.

As shown in FIG. 1 and FIG. 2A, the machining apparatus 100 includes a data compensation device 10, a control unit 20, a control-data storing unit 30, a driving unit 40, and a display unit 50. The data compensation device 10 includes a measuring unit 11, a calculating unit 12, and a storing unit 13. For example, the machining apparatus 100 is a multiple-axis machine tool. The data compensation device 10 is a device for compensating machining data input to the machining apparatus 100.

The machining data input to the machining apparatus 100 is data input by a user via an operation unit such as a keyboard and a mouse. The machining data input to the machining apparatus 100 may include data incorporated in the machining apparatus 100 in advance and data created by the machining apparatus 100. Such data is stored in, for example, the control-data storage unit 30.

The machining apparatus 100 machines work W, which is set on a table 100b, using a tool 100a on the basis of machining data stored in the control-data storing unit 30. For example, in the machining apparatus 100, components (e.g., a machining head 100c and the table 100b) are moved in three axis directions of an X-axis, a Y-axis, and a Z-axis, whereby the position of the tool 100a with respect to the work W changes and machining of the work W is performed.

For example, the machining data stored in the control-data storing unit 30 is data concerning a machine, data concerning a tool, data concerning work, NC (Numerical Control) data, compensation data, and the like.

As shown in FIG. 2B, the data concerning the machine is a machine origin M and an axis configuration (the X-axis, the Y-axis, and the Z-axis) in the machining apparatus 100. The data concerning the tool is, for example, a tool length L and a tool diameter R in the tool 100a. The data concerning the work is, for example, a relative position P of the work W with respect to the machine origin M. The NC data is, for example, an NC code of a coordinate and the like of the work W. The compensation data is a compensation vector at a coordinate point disposed inside a space in which a moving object moves.

A positioning error is caused by a displacement amount from the position of an actual control axis due to translation or rotation. In linear axes of a three-dimensional space, there are six degrees of freedom including positioning (a pitch), straightness degrees in two directions, pitching, yawing, and swing rolling in a turning direction. Among the six degrees of freedom, the positioning and the straightness degrees in the two directions are equivalent to three degrees of freedom concerning a translation deviation. Among the six degrees of freedom, the pitching, the yawing, and the swing rolling in the turning direction are equivalent to three degrees of freedom concerning a rotation deviation.

In the case of a three-axis machining apparatus, in addition to eighteen degrees of freedom concerning the translation deviation and the rotation deviation, three degrees of freedom concerning perpendicularities of three axes overlapping one another are added. That is, in the case of the three-axis machining apparatus, twenty-one degrees of freedom are present.

As shown in FIG. 3, concerning the X-axis, the positioning and the straightness degrees in the two directions are respectively represented by X1, X2, and X3. Concerning the X-axis, the pitching, the yawing, and the swing rolling in the turning direction are respectively represented by X4, X5, and X6.

Concerning the Y-axis, the positioning and the straightness degrees in the two directions are respectively represented by Y1, Y2, and Y3. Concerning the Y-axis, the pitching, the yawing, and the swing rolling in the turning direction are respectively represented by Y4, Y5, and Y6.

Concerning the Z-axis, the positioning and the straightness degrees in the two directions are respectively represented by Z1, Z2, and Z3. Concerning the Z-axis, the pitching, the yawing, and the swing rolling in the turning direction are respectively represented by Z4, Z5, and Z6. The perpendicularities of the three axes overlapping one another are respectively represented by A1 to A3.

As a method of compensating all positioning errors such as pitching, yawing, rolling, and straightness errors of these linear motion axes, there is a geometric error compensation method. In the geometric error compensation method, a space in which a moving object moves is formed as a rectangular parallelepiped, an error at a coordinate point disposed inside the rectangular parallelepiped is measured, and an error during the movement is compensated with reference to a result of the measurement.

As shown in FIG. 3, in the case of the three-axis machining apparatus, the positioning error is caused by twenty-one degrees of freedom. The machining apparatus 100 in the embodiment has three control axes orthogonal to one another. In the machining apparatus 100, a tool and a table on which work is set are moved and machining of the work is performed according to the actions of the X-axis, the Y-axis, and the Z-axis. A U-axis, a V-axis, a W-axis, an auxiliary axis, an additional axis, and the like may be provided in the three-axis machining apparatus including the X-axis, the Y-axis, and the Z-axis.

The measuring unit 11 measures an environmental temperature in the vicinity of the machining apparatus 100 and the position of the machining head 100c (the tool 100a). For example, the measuring unit 11 includes a laser sensor 11a (a position measuring unit) and a temperature measuring device 11b (a temperature measuring unit). The laser sensor 11a measures the position of the machining head 100c. The temperature measuring device 11b measures the temperature of the machining apparatus 100.

The environmental temperature is data concerning a machining environment of the machining apparatus 100. Such data relates to a positioning error. The temperature of the machining apparatus 100 is an external temperature (e.g., an outdoor temperature) of the machining apparatus 100, an internal temperature of the machining apparatus 100, or the temperature of the components in the machining apparatus 100. These temperatures have correlations with the environmental temperature. Therefore, it is possible to create compensation data based on the environmental temperature.

For example, the measuring unit 11 measures, at each environmental temperature, the position of a reflecting body 100c1 (a reflector) provided in the machining head 100c using the laser sensor 11a. In this case, the measuring unit 11 can measure the position of the reflecting body 100c1 using the laser sensor 11a including three heads. By detecting information concerning a distal end position of the tool 100a with the laser sensor 11a, in the machining apparatus 100, it is possible to learn a relative positional relation of the tool 100a with respect to control axes. Data concerning the position of the tool 100a at each environmental temperature is sent to the calculating unit 12.

The calculating unit 12 creates, on the basis of the data sent from the measuring unit 11, a table concerning compensation data associated with environmental temperatures. The compensation data is data concerning the position of the tool 100a. However, when lattice-like regions divided at a fixed interval in the axial directions of drive axes are defined as machining regions, the compensation data is data associated with lattice points (machining points) located in the lattice-like regions. Machining points with small positioning errors can be specified by such compensation data.

The calculating unit 12 calculates, on the basis of the table concerning the compensation data, a compensation value (a geometric error compensation value) of the NC data for compensating a positioning error. That is, the calculating unit 12 calculates a compensation value concerning a position to be machined by the machining apparatus 100. For example, such a compensation value can be calculated on the basis of the environmental temperature and the position of the machining head 100c (the tool 100a) measured by the measuring unit 11 and the position of the machining head 100c (the tool 100a) decided in advance. The calculating unit 12 calculates a compensation value of the NC data corresponding to an environmental temperature. The compensation value of the NC data calculated by the calculating unit 12 is stored in the storing unit 13 or provided to the control unit 20.

The storing unit 13 is, for example, a memory such as a RAM (Random Access Memory). The storing unit 13 stores the compensation value of the NC data.

The control unit 20 acquires the compensation value of the NC data corresponding to the environmental temperature and compensates the machining data (stored in the control-data storing unit 30) with the acquired compensation value. That is, the control unit 20 compensates, on the basis of the compensation value of the NC data, machining data concerning the position to be machined by the machining apparatus 100. The control unit 20 executes geometric error compensation for the NC data.

The control unit 20 is also a device that executes software for checking the operation of the machining apparatus 100. For example, the control unit 20 also has a function of executing software for operating a machine simulation.

The control unit 20 may be a device that executes software for operating CAM (Computer Aided Manufacturing). The control unit 20 may be a device that executes software for operating a system in which the machine simulation and the CAM are integrated.

The control-data storing unit 30 is, for example, a memory such as a RAM or a ROM (Read Only Memory). The control-data storing unit 30 stores a program to be executed in the machining apparatus 100, created data of the machining apparatus 100, input data input by a user, and the like.

The driving unit 40 is a driving device in control axes. The driving unit 40 can be, for example, a unit having a control motor such as a servo motor. The control unit 20 controls the driving unit 40 on the basis of the compensated NC data.

For example, the display unit 50 displays an operation state of the machining apparatus 100 by executing software. For example, the display unit 50 displays results by the CAM and the machine simulation. The display unit 50 may display a result of the measurement by the measuring unit 11 and a result of the calculation by the calculating unit 12. The display unit 50 is, for example, a flat panel display.

Processing for calculation of a compensation value of the NC data by the data compensation device 10 is described below.

A thermal expansion amount of the components of the machining apparatus 100 changes according to a temperature change of the machining apparatus 100. The temperature of the machining apparatus 100 changes according to temperatures in the morning, the daytime, and the night and a degree of machining. The thermal expansion amount is different depending on the machining apparatus 100. Therefore, in the machining apparatus 100, the machining head 100c close to a machining point is moved. Positions of the machining head 100c are measured by the measuring unit 11 of the data compensation device 10. That is, positions of the tool 100a are measured by the measuring unit 11.

A measurement value measured by the measuring unit 11 is sent to the calculating unit 12. The calculating unit 12 calculates, as a compensation value, a difference between compensation data calculated on the basis of the measurement value and reference data, which is a control value. The compensation value is calculated as matrix-like data. Since the compensation value changes according to temperature, the compensation value is calculated for each of a plurality of temperatures (e.g., each of temperatures in the morning, the daytime, and the night) determined within a range of an environmental temperature. The compensation value calculated by the calculating unit 12 is stored in the storing unit 13.

Thereafter, the compensation value is provided to the control unit 20 according to a temperature condition. The control unit 20 compensates machining data of the machining apparatus 100 on the basis of the compensation value. The control unit 20 controls the driving unit 40 on the basis of the compensated machining data and performs machining.

A specific example of geometric error compensation for the NC data executed by the control unit 20 is described below. In FIG. 4A to FIG. 4C, examples of the control unit 20 that executes the geometric error compensation for the NC data are shown.

As shown in FIG. 4A, the NC data (a track of a tool) is created by the CAM. The control unit 20 compensates the NC data on the basis of the compensation value and performs a simulation. When determining that a simulation result is proper, the control unit 20 outputs the simulation result as compensated NC data and controls the driving unit 40 on the basis of the compensated NC data. When determining that the simulation result is not proper, the control unit 20 further compensates the NC data of the machining apparatus 100. For example, the control unit 20 further compensates a difference between the NC data and machining data (a theoretical value) of the machining apparatus 100. In the example shown in FIG. 4A, the control unit 20 is a device that executes the software for operating the machine simulation.

The user checks, through the machine simulation, the operation of the machining apparatus 100, which reflects the geometric error compensation for the NC data, via the display unit 50. When the machine simulation is operated, the operation of the machining apparatus 100, which uses the compensated NC data, is simulatively displayed on the display unit 50. Since the operation of the machining apparatus 100 is visualized, the user can check the operation of the machining apparatus 100. The user can also check the shape of work after being machined by the tool. Therefore, the user can also check whether the work satisfies a desired shape.

After the operation of the machining apparatus 100 and the shape of the work after the machining are checked by the machine simulation, when there is a deficiency, the NC data of the machining apparatus 100 is further compensated. In the machining apparatus 100, a determining unit that determines additional compensation of the NC data may be provided. The NC data of the machining apparatus 100 may be further compensated according to the operation of the operation unit by the user.

As shown in FIG. 4B, the NC data is created by the CAM. The control unit 20 compensates the NC data on the basis of the compensation value. When determining that the compensation of the NC data is proper, the control unit 20 outputs compensated NC data and controls the driving unit 40 on the basis of the compensated NC data. When determining that the compensation of the NC data is not proper, the control unit 20 further compensates the NC data of the machining apparatus 100. In the example shown in FIG. 4B, the control unit 20 is a device that executes the software for operating the CAM.

The user checks a track of the tool of the machining apparatus 100, which reflects the geometric error compensation for the NC data, via the display unit 50. Since the operation of the components of the machining apparatus 100 is visualized, the user can check the operation of the machining apparatus 100. After the operation of the machining apparatus 100 is checked on the display unit 50, when there is a deficiency, the NC data of the machining apparatus 100 is further compensated.

As shown in FIG. 4C, the control unit 20 creates the NC data, compensates the NC data on the basis of the compensation value, and performs a simulation. When determining that a simulation result is proper, the control unit 20 outputs the simulation result as compensated NC data and controls the driving unit 40 on the basis of the compensated NC data. When determining that the simulation result is not proper, the control unit 20 further compensates the NC data of the machining apparatus 100. In the example shown in FIG. 4C, the control unit 20 is a device that executes the software for operating the system in which the machine simulation and the CAM are integrated.

The user checks, on the system, the operation of the machining apparatus 100, which reflects the geometric error compensation for the NC data, via the display unit 50. Since the operation of the machining apparatus 100 is visualized, the user can check the operation of the machining apparatus 100.

After the operation of the machining apparatus 100 is checked on the system, when there is a deficiency, the NC data of the machining apparatus 100 is further compensated.

When the operation of the machining apparatus 100 and the shape of the work are not proper in any one of FIG. 4A to FIG. 4C, CL (Cutter Location) data of the machining apparatus 100 can be modified.

For example, the CL data includes positional information (positional data) of a component in the machining apparatus 100, and the CL data is stored in the control-data storage unit 30 and the like. The positional information of the component in the machining apparatus 100 is modified by modifying the CL data. For example, the positional information of the component is directed to information which represents the position of the machining head 100c (the tool 100a) by a coordinate value.

After the CL data is modified, the control unit 20 performs a simulation based on the modified CL data again and determines whether a simulation result is proper. The user checks the operation of the machining apparatus 100 and the shape of the work based on the modified CL data. That is, the user checks the operation of the machining apparatus 100 and the shape of the work based on the NC data corresponding to the modified CL data.

Alternatively, when the operation of the machining apparatus 100 is not proper in any one of FIG. 4A to FIG. 4C, the compensation value can be created again. In such a case, it is assumed that, in the operation of the machining apparatus 100, the geometric error compensation for the NC data is not sufficiently reflected. For example, it is assumed that a measurement error due to the measuring unit 11 occurs.

After the compensation value is created again, the control unit 20 compensates the machining data of the machining apparatus 100 on the basis of the compensation value created again. When the compensation value is created again, the compensation value may be automatically created in the machining apparatus 100. Alternatively, the user may create the compensation value via the operation unit or the like.

When the operation of the machining apparatus 100 is proper in any one of FIG. 4A to FIG. 4C, the NC data of the machining apparatus 100 is changed. The driving unit 40 is controlled according to the changed NC data (compensated NC data) and the work is machined.

In a machining apparatus that machines work using a plurality of control axes, the position of actual machining point is sometimes different from the position of a machining point determined on the basis of input data. Such a positioning error affects machining accuracy of the work.

In order to compensate the positioning error, there has been proposed a technique for providing a measuring device that measures an actual position and calculating a compensation value from a difference between measurement data and input data. However, an environmental temperature changes as time elapses. The compensation value also changes because of thermal expansion and the like. Therefore, the measurement and the calculation of the compensation value are necessary every time machining is performed. Propriety of compensation is often unknown unless machining is actually performed using calculated compensation value. Consequently, it is difficult to evaluate a compensation result before an actual operation of the machining apparatus.

The number of compensation values to be calculated and the number of compensation tables are sometimes small. Further, depending on a machining apparatus, the geometric error compensation for the NC data cannot be executed. Consequently, the machining accuracy of the work is deteriorated by a positioning error.

With the machining apparatus 100 of the embodiment, the NC data subjected to the geometric error compensation corresponding to the environmental temperature is created. It is possible to perform machining according to the compensated NC data. It is possible to check the operation of the machining apparatus 100 based on the NC data using the control unit 20. If there is a deficiency, it is possible to change the NC data. Therefore, it is also possible to evaluate a compensation result before an actual operation of the machining apparatus 100.

In this case, the control unit 20 can be attached to an existing apparatus that cannot execute the geometric error compensation for the NC data. Further, it is possible to increase the number of compensation values and the number of compensation tables according to a machining environment. It is possible to perform the geometric error compensation for the NC data on the basis of a plurality of compensation values and a plurality of compensation tables. Consequently, it is possible to increase machining accuracy of the machining apparatus 100.

According to the embodiment, the data compensation device and the machining apparatus that can perform machining with higher machining accuracy are provided.

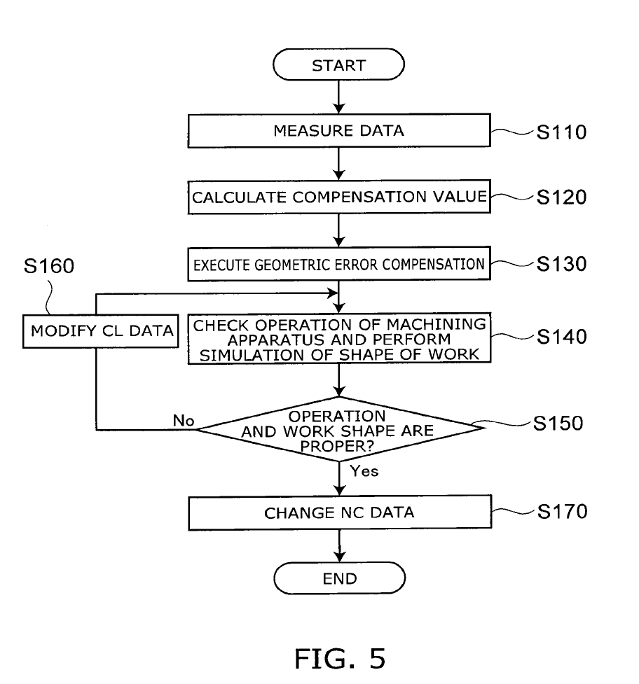

FIG. 5 is a flowchart for describing a data compensation method according to the embodiment.

As shown in FIG. 5, first, an environmental temperature is measured and data corresponding to the temperature of the machining apparatus 100 is measured (step S110). For example, the measuring unit 11 measures the position of the tool 100a at each environmental temperature and sends data concerning the position of the tool 100a to the calculating unit 12.

A compensation value of the NC data for compensating a positioning error is calculated (step S120). For example, the calculating unit 12 calculates a compensation value of the NC data on the basis of the data sent from the measuring unit 11. After the calculating unit 12 acquires the compensation value of the NC data corresponding to the environmental temperature, the compensation value is stored in the storing unit 13 or provided to the control unit 20.

The geometric error compensation for the NC data is executed on the basis of the compensation value (step S130). For example, the control unit 20 compensates machining data concerning a position to be machined by the machining apparatus 100 on the basis of the compensation value of the NC data.

The operation of the machining apparatus 100, which reflects the geometric error compensation for the NC data, and the shape of the work after the machining are checked (step S140). For example, the control unit 20 is also a device that executes software for checking the operation of the machining apparatus 100. The operation of the machining apparatus 100 and the shape of the work are displayed by the display unit 50 according to the execution of the software and checked by the user.

After the operation of the machining apparatus 100 and the shape of the work are checked, it is determined whether the operation of the machining apparatus 100 and the shape of the work are proper (step S150). The control unit 20 and the user determine whether the operation of the machining apparatus 100 and the shape of the work are proper.

When it is determined that the operation of the machining apparatus 100 and the shape of the work are not proper (No), the CL data of the machining apparatus 100 is modified (step S160). After the CL data is modified, the operation of the machining apparatus 100 and the shape of the work based on the modified CL data are checked.

When it is determined that the operation of the machining apparatus 100 and the shape of the work are proper (Yes), the NC data of the machining apparatus 100 is changed (step S170). The driving unit 40 is controlled according to the changed NC data and the work is machined.

According to the embodiment, the data compensation method that can perform machining with higher machining accuracy is provided.

A processing method for storing, in a storage medium, a program for operating the configuration of the embodiment to realize the functions of the embodiment (e.g., a program for executing the processing in FIG. 5), reading out, as a code, the program stored in the storage medium, and executing the program in a computer is also included in the category of the embodiment. A computer-readable recording medium is included in the scope of the embodiment. The computer program itself stored in the storage medium is also included in the embodiment.

As the storage medium, for example, a floppy (registered trademark) disk, a hard disk, an optical disk, a magneto-optical disk, a CD-ROM, a magnetic tape, a nonvolatile memory card, and a ROM can be used.

Not only the program stored in the storage medium executing the processing alone but also a program operating on an OS and executing the operation of the embodiment in cooperation with functions of other software and an extension board is included in the category of the embodiment.

According to the embodiment, the data compensation device, the data compensation method, and the machining apparatus that can perform machining with higher accuracy are provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A data compensation device comprising:
a temperature measuring unit configured to measure an environmental temperature in a vicinity of a machining apparatus;
a position measuring unit configured to measure a position of a component of the machining apparatus decided in advance; and
a calculating unit configured to calculate a geometric error compensation value corresponding to each of a plurality of environmental temperatures on the basis of the environmental temperature measured by the temperature measuring unit, the position of the component measured by the position measuring unit, and the position of the component decided in advance.

2. The device according to claim 1, wherein the calculating unit calculates the geometric error compensation value on the basis of a coordinate value in a space in which the component moves.

3. The device according to claim 1, wherein the temperature measuring unit measures any one of an external temperature of the machining apparatus, an internal temperature of the machining apparatus, and a temperature of the component.

4. The device according to claim 1, wherein
the component includes a reflecting body, and
the position measuring unit measures a position of the reflecting body.

5. The device according to claim 1, further comprising a storing unit configured to store the geometric error compensation value.

6. A machining apparatus comprising:
a data compensation device including:
a temperature measuring unit configured to measure an environmental temperature in a vicinity of the machining apparatus;
a position measuring unit configured to measure a position of a component of the machining apparatus decided in advance; and
a calculating unit configured to calculate a geometric error compensation value corresponding to each of a plurality of environmental temperatures on the basis of the environmental temperature measured by the temperature measuring unit, the position of the component measured by the position measuring unit, and the position of the component decided in advance;
a driving unit configured to drive the component; and
a control unit configured to control the driving unit,
the control unit compensating input machining data using a geometric error compensation value corresponding to the environmental temperature measured by the temperature measuring unit.

7. The apparatus according to claim 6, wherein the calculating unit calculates the geometric error compensation value on the basis of a coordinate value in a space in which the component moves.

8. The apparatus according to claim 6, wherein the temperature measuring unit measures any one of an external temperature of the machining apparatus, an internal temperature of the machining apparatus, and a temperature of the component.

9. The apparatus according to claim 6, wherein
the component includes a reflecting body, and
the position measuring unit measures a position of the reflecting body.

10. The apparatus according to claim 6, wherein the data compensation device further includes a storing unit configured to store the geometric error compensation value.

11. The apparatus according to claim 6, wherein the control unit determines propriety of the compensated machining data.

12. The apparatus according to claim 6, wherein the control unit includes a device that executes software for determining propriety of the compensated machining data.

13. The apparatus according to claim 6, further comprising a display unit configured to display an operation of the machining apparatus.

14. A data compensation method comprising:
measuring an environmental temperature in a vicinity of a machining apparatus and a position of a component of the machining apparatus decided in advance;
calculating a geometric error compensation value corresponding to each of a plurality of environmental temperatures on the basis of the measured environmental temperature, the measured position of the component, and the position of the component decided in advance; and
compensating input machining data using a geometric error compensation value corresponding to the measured environmental temperature.

15. The method according to claim 14, further comprising changing the machining data on the basis of the compensation of the machining data.

16. The method according to claim 15, further comprising determining propriety of the compensated machining data, wherein
the machining data is changed when it is determined that the compensated machining data is proper.

17. The method according to claim 16, wherein positional data of the component is modified when it is determined that the compensated machining data is not proper.

18. The method according to claim 14, wherein the geometric error compensation value is calculated on the basis of a coordinate value in a space in which the component moves.

19. The method according to claim 14, wherein the measuring the environmental temperature includes measuring any one of an external temperature of the machining apparatus, an internal temperature of the machining apparatus, and a temperature of the component.

20. The method according to clam 14, wherein
the component includes a reflecting body, and
the measuring the position of the component includes measuring a position of the reflecting body.
